(19) United States
(12) Patent Application Publication
(10) Pub. No.: US 2020/0151595 A1
(43) Pub. Date: May 14, 2020

(54) AUTOMATED TRAINING AND EXERCISE ADJUSTMENTS BASED ON SENSOR-DETECTED EXERCISE FORM AND PHYSIOLOGICAL ACTIVATION

(71) Applicant: Mad Apparel, Inc., Redwood City, CA (US)

(72) Inventors: Dhananja Pradhan Jayalath, San Francisco, CA (US); Christopher John Wiebe, Burlingame, CA (US); Donald William Faul, Woodside, CA (US)

(21) Appl. No.: 16/683,829

(22) Filed: Nov. 14, 2019

Related U.S. Application Data
(60) Provisional application No. 62/767,231, filed on Nov. 14, 2018.
(60) Provisional application No. 62/767,236, filed on Nov. 14, 2018.

(51) Int. Cl. G06N 5/04; G06N 20/00

(52) U.S. Cl. CPC G06N 5/04; G06N 20/00

(57) ABSTRACT

The invention(s) described are configured to process sensor data in order to optimize or otherwise improve training of users for achievement of goals in relation to performing an activity. The invention(s) can also iteratively adapt training in a personalized manner, with assessment of training results and subsequent modification of training regimens, in order to provide improved alignment between users and their goals. Such iteration can drive interventions provided to users throughout the course of training, and allow the system to iteratively develop better and more precise interventions (e.g., through manual means, through machine learning models with generated training and test data). Such iteration, with large datasets applied to populations of users can also increase the breadth of user states that the can be addressed, with respect to provided interventions, and improve rates at which interventions are provided.

### CROSS REFERENCE TO RELATED APPLICATIONS

This application claims the benefit of U.S. Provisional Application Ser. No. 62/767,231 filed 14 Nov. 2018 and U.S. Provisional Application Ser. No. 62/767,236 filed 14 Nov. 2018, which are each incorporated in its entirety herein by this reference.

### BACKGROUND

This description generally relates to sensor-equipped athletic garments and connected exercise equipment, and specifically to providing tools to entities for improving user performance based upon inputs and physiological data from the sensors. The description also relates to modulating connected device operation based upon inputs and physiological data from the sensors.

Sensors record a variety of information about the human body. For example, electromyography (EMG) electrodes can measure electrical activity generated by a person's muscles. In relation to training of individuals, and especially in relation to self-training or remote training, current technologies do not enable coaching entities to monitor physiological states of individuals they are coaching and/or efficiently tune exercise regimens for athletes in a personalized and real-time and/or post/non-real-time manner. Since individuals may have personalized needs in relation to improving performance, it is desirable for systems to automatically tailor metrics and instruction by taking into account physiological states.

### SUMMARY

The invention(s) relate to systems and methods for enabling people to lead better and healthier lives, by improving how they train for activities and achieve activity-specific and health-specific goals. In relation to improvements in training, the invention(s) provide a platform for customizing and optimizing training to user goals and user physiology. Customization is provided in the context of factors including life constraints (e.g., work requirements), activity-specific goals, health goals, user physiology, user responses to training stimuli, user motivation style in relation to engagement, and other factors. Such customization is provided to “the everyday user”, non-elite athletes, and elite athletes.

The invention(s) described can also iteratively adapt training in a personalized manner, with assessment of training results and subsequent modification of training regimen, in order to provide improved alignment between users and their progress/needs. Such iteration can drive interventions provided to users throughout the course of training, and allow the system to iteratively develop better and more precise interventions (e.g., through manual means, through machine learning models with generated training and test data). Such iteration, with large datasets applied to populations of users can also increase the breadth of user states that the system is capable of responding to, with respect to provided interventions, and improve rates at which interventions are provided. The system can thus perform methods that cannot be practically implemented in the human mind, with respect to processing of digital objects and signals extracted from sensors, and processing of large datasets in a time-sensitive manner.

As such, the system(s) and method(s) described involve: acquisition of sensor and other data, analysis of sensor and other data in order to understand user-specific deficiencies (e.g., in relation to performance goals and other goals), generation of relevant system outputs and interventions for improving user training and performance, and providing outputs to users and associated entities for improving user engagement during training. Such a feedback loop is configured to drive users to efficiently achieve goals. Sensor and other data can include contextual data, environmental data (e.g., from a set of environment sensors in an environment of the user, where the set of environment sensors comprises a temperature sensor and an altitude sensor, and/or other sensors), and other data, depending upon desired outcomes. Analyses are configured based on market/user audience needs, data types, and desired outcomes.

In more detail with regard to embodiments of the invention(s) described, a goal of training and strength and conditioning is to prepare an athlete for the demands of their life and to reach goals (e.g., weight loss, speed, endurance, strength, etc.). Tailoring training based on the specific requirements for an individual and their personalized goals has proved to be difficult in conventional systems, largely due to the inability to understand physiological states (e.g., states of activation of different muscle groups) are on each portion of the body during training. EMG, cardiovascular, motion, and other sensors provide a measure of neuromuscular function in relation to activation states of different muscle groups of the user. Furthermore, contextual data related to user activities being performed are processed with sensor data to identify user deficiencies.

As described, embodiments of an exercise feedback system generate biofeedback based on physiological adaptations. The exercise feedback system processes physiological data from sensor-equipped athletic garments worn by athletes while performing exercises. The physiological data may include EMG signals indicative of muscle activation levels, from which derivative metrics can be extracted to generate relevant outputs for improving athlete performance. Such outputs can include high resolution feedback for improving performance, and/or control instructions for connected equipment with which the athlete(s) interact.

In one embodiment, the physiological data can thus be used to notify the user and/or an entity (e.g., coaching entity) associated with the user of incorrect form and take corrective action to better achieve training goals. Variations of the system and method can be used for remote coaching of persons or athletes, in a live or asynchronous manner (e.g., in relation to development of coaching plans and performance of a plan by a user). In particular, coaching entities and/or automated systems associated with the invention(s) are configured to analyze data and iteratively modify user training in relation to user goals and user-specific deficiencies and constraints.

In another embodiment, in relation to a received input associated with a training goal, the physiological data can be used by the exercise feedback system to generate control instructions for automatically modulating operation states of connected exercise equipment, in order to produce desired levels of muscle activation from the desired muscles to meet the training goal. Additionally or alternatively, outputs of the system and/or method can be used to provide coaching entities with tools for adjusting exercise regimen aspects for a group or individuals they are coaching.

### BRIEF DESCRIPTION OF DRAWINGS

FIG. 1 is a diagram of a system environment for automating training and/or providing feedback based on physiological adaptations and/or sensor-detected exercise form, according to one or more embodiments.

FIG. 2A depicts a flowchart of a method for providing feedback on form and effort based on physiological data from athletic garment, in accordance with one or more embodiments.

FIG. 2B is a diagram of entities involved in the exercise feedback system connected by the steps disclosed in FIG. 2A, according to one or more embodiments.

FIG. 3A depicts a flowchart of a method for automatically modulating operation states of connected exercise equipment, in order to produce desired levels of muscle activation for one or more users, in accordance with one or more embodiments.

FIG. 3B is a diagram of entities involved in the exercise feedback system connected by the steps disclosed in FIG. 3A, according to one or more embodiments.

FIG. 4 is a diagram of entities involved in a training regimen, according to one or more embodiments.

FIGS. 5A, 5B, and 5C are illustrations of the functionality of providing form and effort feedback and/or automating adjustments to exercise equipment operation based on sensor-detected data, according to some embodiments.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### I. System Overview

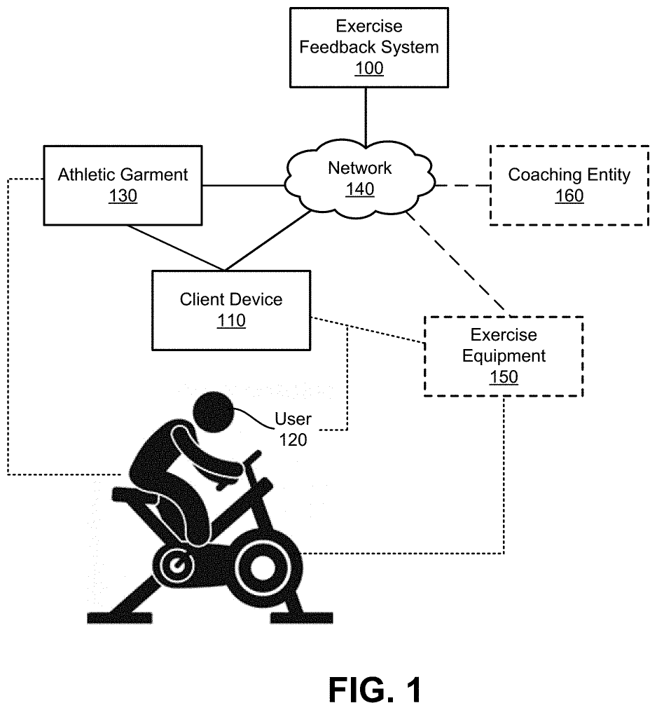

FIG. 1 is a diagram of a system environment for automatically modulating exercise equipment operation states based on physiological states of an individual, according to one or more embodiments. The system environment includes an exercise feedback system 100, a client device 110, and athletic garment 130 communicatively coupled together via a network 140. The system environment can also include one or more connected exercise equipment units 150 communicatively coupled to the network 140, where the connected exercise equipment units 150 receive control instructions generated based on outputs of other system components, in order to automatically adjust equipment settings in relation to a training goal. In embodiments, exercise equipment 150 can include one or more of: a treadmill, an elliptical, a stationary bike, a rowing machine, a stair-stepper, a cross-country skiing machine, a cable column with weights, a squat machine, a chest press machine, other single-purpose machines, other multi-purpose machines, etc. In variations, exercise equipment can include non-connected exercise equipment.

The athletic garment 130 includes sensors and electronics configured to receive biometric signals from a user and transmit biometric signals to one or more portions of the system as the user performs an activity. Users, including user 120, of the exercise feedback system 100 may also be referred to herein as “athletes”. Other entities associated with the exercise feedback system 100 can also include coaching entities, including a coaching entity 160, where coaching entities can provide inputs to the exercise feedback system 100 and/or receive outputs of the exercise feedback system 100. In other embodiments, different and/or additional entities can be included in the system architecture. For instance, as described below, the coaching entity 160 can be a human entity or a non-human entity (e.g., a virtual coaching entity).

The coaching entity 160 interacts with the user 120 and/or multiple users (as described in more detail below). In some embodiments the coaching entity 160 and user 120 are physically present together while executing the workout. In another embodiment, the coaching entity 160 is not physically with the user 120 but is acting remotely to provide feedback in real-time or non-real time. As such, in some embodiments the interactions between the user 120 and coaching entity 160 can occur contemporaneously or may occur at different times (e.g., a coach may develop a plan prior to an intended workout time of a user). That is, the coaching entity 160 can plan a workout (e.g., with a consulting athlete) during a first time window and the user 120 executes the workout plan in a second time window. At a subsequent time, the coaching entity 160, alone or in combination with computing entities, reviews the data captured about the user's 120 workout and provides coaching feedback, such as altering future workout plans and/or providing other interventions. The network 140 keeps the coaching entity 160 connected to the user 120, even if they are separated by time or physical location.

Furthermore, the coaching entity 160 may be working with a group of users 120, such as teaching a class or team of athletes. Additionally, the coaching entity 160 and user 120 may be in a one-on-one setting wherein there is only one use 120. The one-on-one coaching may occur in-person, remotely, in real-time, or in any of the other embodiments previously described. The coaching entity 160 may be a real person or a virtual coach based on software, such as artificial intelligence (AI). Similarly, a coaching entity 160 that is a real person may use AI as a tool to more effectively provide coaching advice to a group of users 120.

The system environment thus includes elements that include functionality for providing feedback on form and effort to one or more users 120 to meet respective training goals. Additionally or alternatively, the system environment includes elements that include functionality for modulating exercises intended to be performed by the one or more users 120, in order to meet respective training goals. Form is determined based on which of a set of muscles activate, when they activate, and how much they activate for a particular exercise or movement. Balance is associated with form of the user 120. For example, a particular exercise has a form definition of activating quadriceps femoris (quads) before gluteal muscles (glutes). A more detailed form definition includes 25% normalized activation of glutes followed by 5% normalized activation of glutes. As part of balance, a more detailed form definition can define activation for left quad separate from right quad, and so on. Effort is defined in relation to the activation of muscles, which can be on a basis per exercise or movement, muscle group, a particular muscle, or any combination thereof.

The system environment additionally or alternatively includes elements that include functionality for automatically modulating operation states of connected exercise equipment, in order to produce desired levels of muscle activation for one or more users 120 to meet respective training goals.

The system environment can additionally or alternatively include embodiments of system aspects described in any one or more of: U.S. application Ser. No. 16/409,373 filed 10 May 2019 and incorporated in its entirety by this reference and below as Appendix A, U.S. application Ser. No. 15/762,542 filed 22 Mar. 2018 and incorporated in its entirety by this reference and below as Appendix B, U.S. application Ser. No. 15/676,917 filed 14 Aug. 2017 and incorporated in its entirety by this reference and below as Appendix C, and U.S. App. No. 62/671,309 filed 14 May 2018 incorporated in its entirety by this reference and below as Appendix D.

### II. Methods

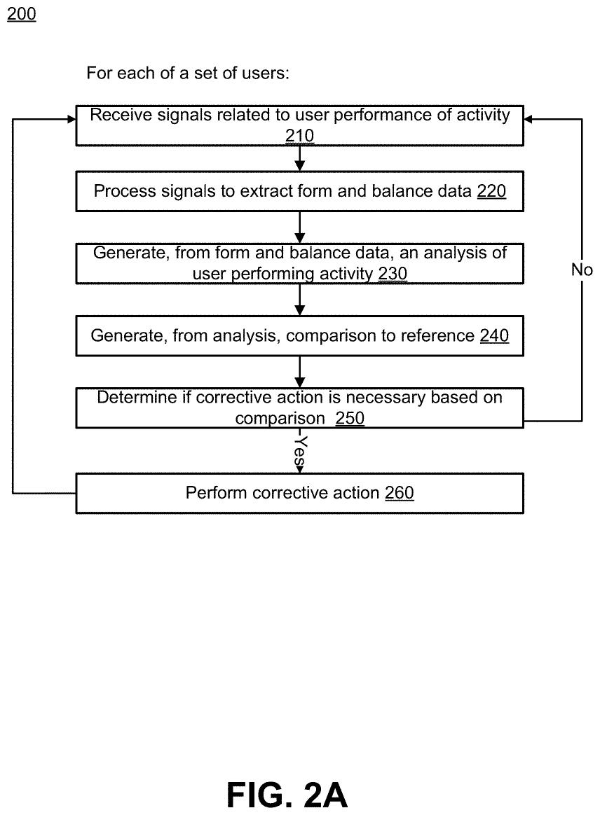

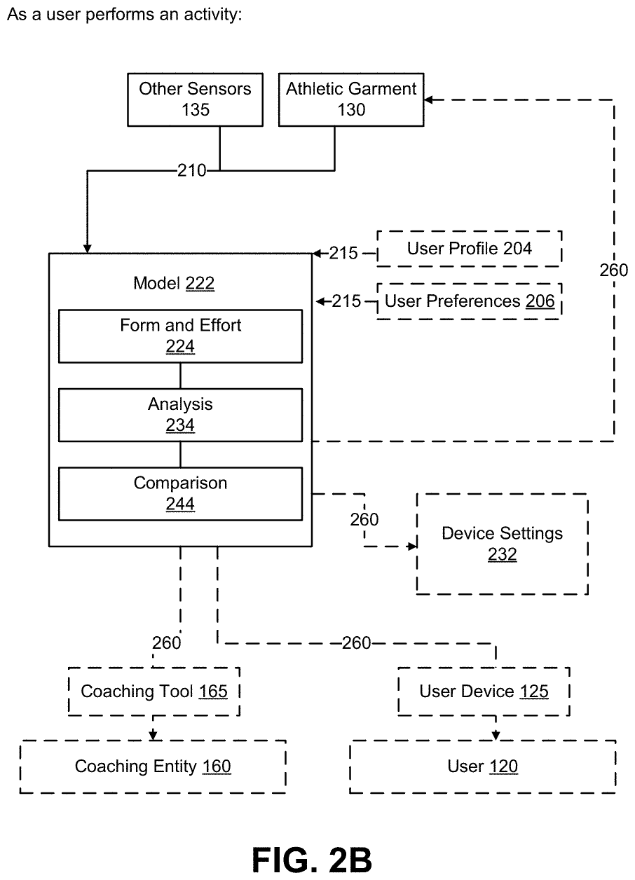

FIG. 2A depicts a flowchart of a method 200 for automatically providing feedback on form and effort based on physiological data from the athletic garment 130, in accordance with one or more embodiments. In more detail, for each set of users, an exercise feedback system (such as the exercise feedback system 100 in FIG. 1) receives a set of signals related to user performance of an activity 210 (described in more detail below in relation to FIG. 2B), processes signals to extract form and effort data 220, generates, from form and effort data, an analysis of user performing the activity 230, generates, from the analysis, a comparison to a reference 240, determines if corrective action is necessary based on comparison 250, and, if determined that corrective action is necessary, performs the corrective action 260. In some embodiments, received signals from sensors or sources other than the athletic garment 130 can be provided as an input for generation of additional feedback on form and effort. Furthermore, in some applications, corrective actions and interventions are configured to improve user engagement with the system, in order to increase efficiency in achieving goals and overcoming deficiencies.

FIG. 2B is a diagram of entities involved in the feedback system connected by the steps disclosed in FIG. 2A, according to one or more embodiments. As shown in FIG. 2B, in relation to step 210, the model 222 receives a set of signals, including signals from the athletic garment 130 and signals from other sensors 135 (e.g., cardiovascular signal sensors, motion sensors, biometric sensors, contextual sensors within the user's environment, etc.). The model 222 may receive other inputs 215. Other inputs 215 may include a user profile 204 or a set of user preferences 206. Other inputs 215 can also include feedback related to settings of the exercise equipment, forces experienced at components of the exercise equipment that contact the user as the user performs the exercise activity, or other exercise equipment information. Other inputs 215 can additionally or alternatively include information related to activities being performed by the user (e.g., based on inputs provided by the user and/or associated coaching entities to the system).

In embodiments, the systems described can thus be configured to perform one or more of the following: receiving a set of signals related to user performance of an activity, from a garment worn by a user, the garment including a set of sensors configured to generate the set of signals; extracting a performance dataset upon processing the set of signals, the performance dataset characterizing form and exertion features across a set of muscles of the user in association with performance of the activity, wherein determining the performance dataset comprises generating, for each of the set of muscles, a value of normalized activation relative to a baseline activation for the set of muscles of the user; generating, from the performance dataset, an analysis of the user performing the activity based upon a comparison to a reference profile associated with a goal of the user; generating a recommended action based upon the analysis and executing the recommended action through an exercise feedback system in communication with the garment; and promoting engagement between the user and the exercise feedback system based upon the analysis and in coordination with executing the recommended action, wherein promoting engagement comprises returning, for communication to the user, an output indicating performance of the user relative to performance of a competitor.

The signals from the athletic garment 130 and the other sensors 135 include raw data about physiological performance. The data may include the activation of individual muscles, muscle tension, heart rate, blood pressure, body temperature, skin temperature, and other measurable physiological data. In relation to activation, in some embodiments, activation can be characterized in terms of normalized activation, a measure of the user's activation relative to the baseline activation level (e.g., maximum exertion level) for a particular physical exercise. Furthermore, the normalized activation can be determined across a set of muscles (e.g., as an aggregate measurement), and/or for individual muscles, in relation to form and effort of a user. The normalized activation and/or the baseline activation are dynamic and can change as the user becomes stronger and faster. In one implementation, a set of signals related to user performance of the activity can include signals derived from one or more of: a subset of the set of muscles being activated, temporal aspects associated with activation of the subset of muscles, and intensity aspects associated with activation of the subset of muscles (e.g., with respect to activation-derived parameters). Determination of normalized activation can be implemented according to embodiments described in U.S. application Ser. No. 15/676,917 filed 14 Aug. 2017 and incorporated in its entirety below as Appendix C.

The signals from the athletic garment 130 are measured by sensors embedded in the material of the athletic garment 130. The signals from other sensors 135 may include other technology used to measure physiological data, such as an accelerometer, balance sensors (such as those embedded in a mat beneath the user 120), sensors that may be included in the exercise equipment 150, optical sensors generating video or other visual recordings of the user 120, and other systems for measuring dynamic physiological data.

The user profile 204 may include information about the particular individual user 120, which includes one or more of: demographic information, medical history, anatomic information, and the user's baseline activation. Demographic information can include age, gender, ethnicity, socioeconomic status, and other demographic information. Medical history may further include a risk of cardiovascular problems, a list of orthopedic injuries, surgical history, and other medical history information. Anatomic information may further include height, weight, limb lengths, and other user-specific aspects of musculoskeletal anatomy. The user profile 204 can also contain a workout history, including past exercises performed, information on how well the user 120 performed the exercises, information about potentially lacking muscle groups, and successful ways the exercise feedback system has corrected the user's 120 form in the past. The user profile 204 can be stored in memory, and the exercise feedback system can retrieve one or more elements of the user profile 204 and input the elements into the model 222, as described below.

The user preferences 206 allow the users some freedom to customize their own workout. For example, in one embodiment, if the user wants to lessen their workout for reasons such as being sore from a previous workout, not feeling well, having an event after the workout, or other reasons, such inputs can be provided (through user-associated devices) to the model 222, and to generate device settings 232 received by the exercise equipment 150 to reduce the user's overall muscle activation, while performing associated exercises, by a factor (e.g., a scaling factor of 15%) related to the user input.

As shown in FIGS. 2A and 2B, the exercise feedback system includes architecture for processing the signals and inputs with a model 222 to extract form and effort data 224, 220 of a performance dataset. The form and effort data 224 is then used to generate an analysis 234 of the user 120 performing an activity 230 (e.g., in relation to user goals, in relation to identification of user deficiencies). The analysis 234 is then used to generate a comparison 244 of the user's 120 performance to a reference 240. The comparison 244 is used to determine if corrective action related to an intervention is necessary 250, in order to optimize training for the user to achieve his/her goals. As such, the system can generate a performance dataset by extracting one or more of: form, balance, and exertion of the user during performance of the activity, upon processing the set of signals with a performance model configured to transform the set of signals into values of features of the performance dataset. The performance model can transform input signal data and return derivative measures of performance of the activity, where training of the performance model is described in more detail below. Furthermore, the system can further generate a characterization of performance of the activity by the user in relation to the reference profile (e.g., derived from an athlete, etc.).

The form and effort data 224 may include data relating to muscle activation, where normalized activation is described above. The muscle activation data are collected from the sensors in the athletic garment 130. Form data 224 may also include video recorded of the user 120 performing the exercise. Balance data 224 may also come from other sensors 135, such as sensors embedded in a mat on the ground beneath the user 120 that detects how the user's 120 weight is being placed. Form data 224 can also be derived from inertial measurement units (IMUs) or other sensors configured to detect motion of different body regions of a user.

The analysis 234 includes steps for processing the form and effort data 224. In some embodiments, the form and effort data 224 such as muscle activation may be analyzed with respect to target activation. The target activation level describes the desired degree of physical exertion of certain muscle group(s) for a particular exercise. The target activation level can be defined in relation to a baseline activation level, as described above. The baseline activation may be stored in the user profile 204. The target activation can be changed by the user preferences 206 (e.g., related to lifestyle constraints, such as daily obligations, work-related constraints, etc.).

Generating the analysis 234 can include characterizing proper form for a user based on parameters customized to the user and/or parameters universally applied across all users. As such, characterization of poor form can be based on parameters that are applied consistently across all users performing an exercise (e.g., multiple users exhibiting imbalance in muscle activation between left- and right-side muscle groups can be provided with the same feedback). Additionally or alternatively, characterization of poor form can be based on parameters that are applied in a customized manner for a particular user. In one example, a user's history of performing the exercise, muscle build, and other characteristics (e.g., user injuries) can be processed by the model in generating the analysis 234 and executing a corrective action, as described below.

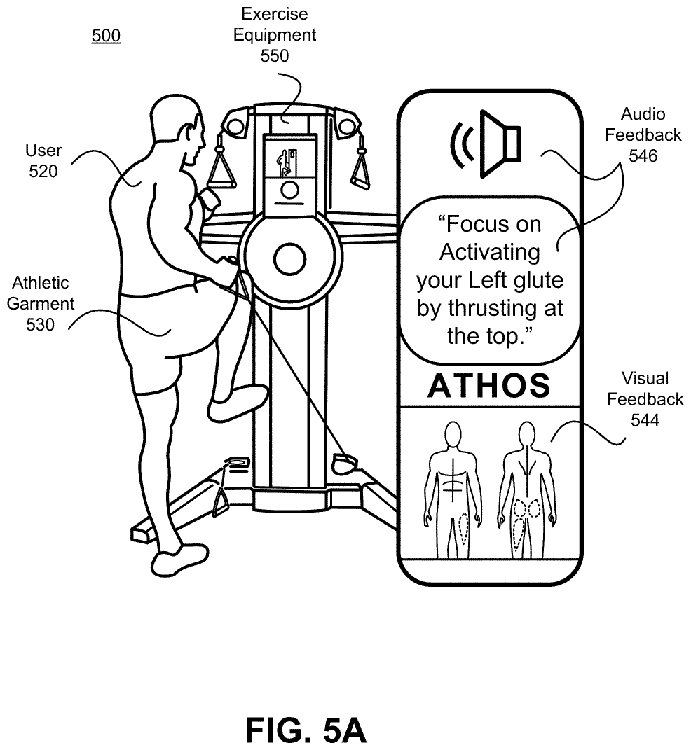

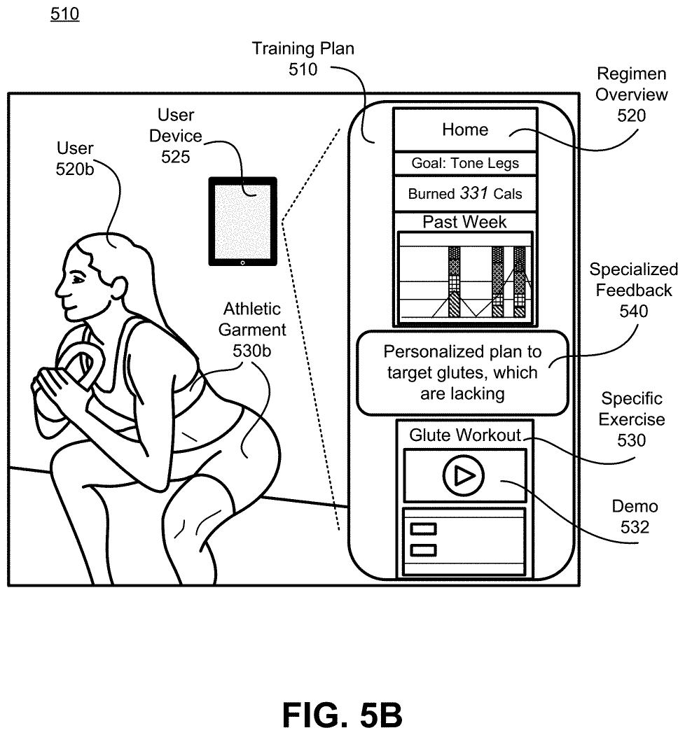

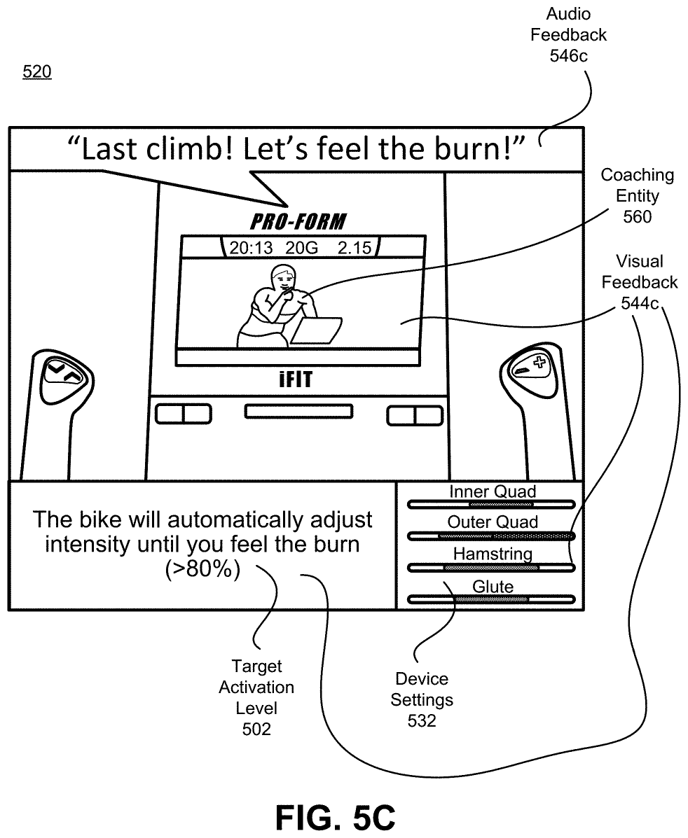

By analyzing the form and effort data 224 with respect to the target activation, an analysis 234 is produced that puts the form and effort data 224 in terms of the target activation level. The analysis may be performed by normalizing the form and effort data with respect to the baseline activation to produce what is known as normalized activation. The analysis 234 may also take into account inputs such as user profile 204 and/or user preferences 206. For example, as shown in FIG. 5B, if user history data included in the user profile 204 indicates that the user's 120 glutes are lacking, the exercise feedback system will take this into account (shown in FIG. 5B). The analysis 234 processes such user history data, and may also include information on how to possibly correct form based on historical data (as described below in relation to executing a corrective action).

In generating the comparison 244 to a reference 240, the exercise feedback system compares user form, effort, and other outputs to an ideal or near-ideal standard of how the user 120 should be performing the exercise. The reference may contain information about the target activation for each muscle or muscle group involved in the exercise. The comparison 244 may include comparing the current muscle activation to an ideal muscle activation. The ideal muscle activation may be personalized for the user's 120 baseline activation. In some embodiments, the comparison may occur on a muscle-by-muscle basis, muscle-group-by-muscle-group basis, the basis of an overall activation, muscle activation level with respect to time, or any combination of the aforementioned.

For example, the user may be performing squats. In generating the comparison 244, the exercise feedback system can process an input from the analysis 234 that the normalized activation of the glute muscles is 50%. The reference for this exercise contains the data that the ideal standard of glute activation is 70%. Hence the comparison 244 would return the result that the glutes are under-activated. In this example, a determination is that corrective action is necessary 250.

If the comparison results in a determination that corrective action is necessary, then the corrective action is performed 260. The corrective action may take various forms in one or more embodiments, such as providing feedback to a coaching entity 260, in some cases via a coaching tool, providing feedback to a user 120, in some cases via a user device, altering the device settings 232 of the connected exercise equipment 150, providing feedback to the athletic garment 130, or changing the workout plan.

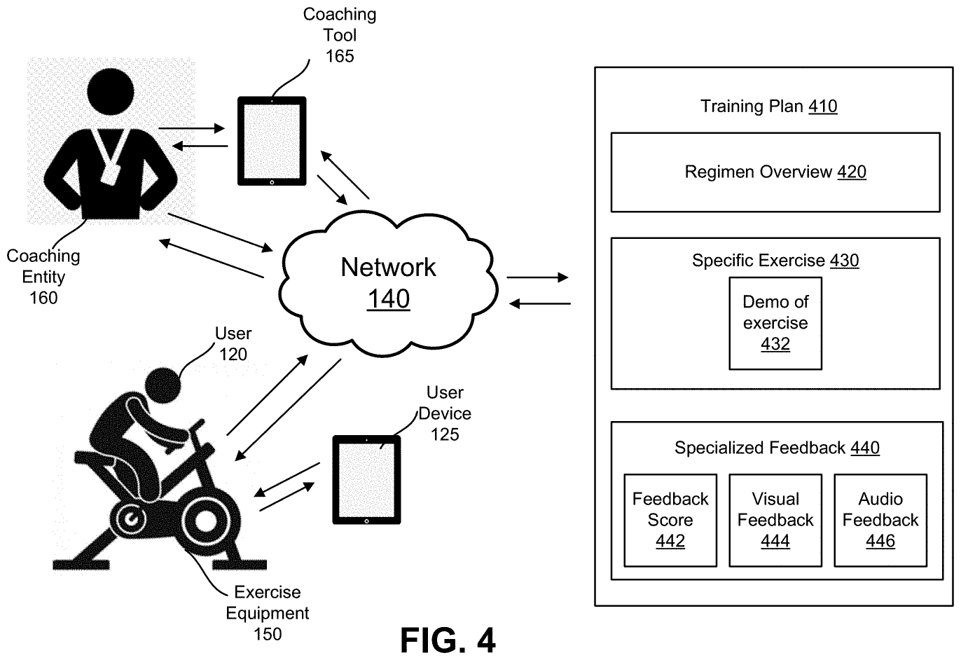

Providing feedback to the coaching entity 160 may be performed via a coaching tool 165. Providing feedback to the user 120 may be performed via a user device 125. Examples of the coaching tool 165 and/or the user device 125 include an electronic tablet, smart phone, smart watch, laptop computer, desktop computer, or another such electronic device. In many embodiments the information and data is provided to the coaching tool 165 and user device 125 via an internet connection, such as a wireless internet connection (for example, the network 140 of FIG. 1). The specific feedback provided will be discussed in greater detail in relation to FIG. 4.

Altering device settings 232 may include various mechanisms to correct the form of the user 120. In one embodiment, the exercise feedback system generates instructions for altering the device settings 232 to increase weight or resistance settings of the exercise equipment 150 to prevent the user 120 from using certain muscles they should not be using, in order to improve form. In another embodiment, the exercise feedback system generates instructions for altering the device settings 232 to decrease weight or resistance settings to get the user 120 to use certain muscles they are not currently using but should be using, in order to improve form. In the case of machines that use incline, such as a treadmill or elliptical, the incline of the machine may be increased or decreased similarly to assist the user 120 in achieving proper form. The device settings 232 may also cause the connected exercise equipment 150 to provide the user 120 with audio or visual feedback about how to correct their form.

Performing the corrective action can further include providing haptic feedback, for instance, through haptic output devices coupled to the athletic garment 130 or to the user in another manner. For instance, for muscle groups requiring modified activation in order to improve form, the exercise feedback system can generate instructions for producing a perceivable haptic output at the region(s) of the athletic garment 130 corresponding to the targeted muscle groups, in order to help the user to correct form.

Performing the corrective action can also include changing the workout plan for the current workout or future workouts. For example, if a user is struggling to perform a particular exercise, it may be eliminated from workout plans and replaced with a different exercise that works similar muscle groups. Specifically, the workout plans in the following days are altered to include supplemental exercises that compensate, correct, and develop strength of the user's 120 form to the movements that were determined to have lacking form and/or effort.

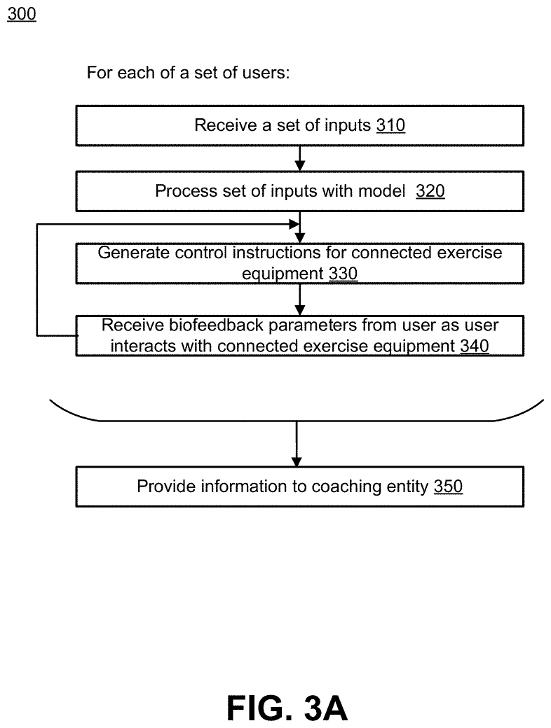

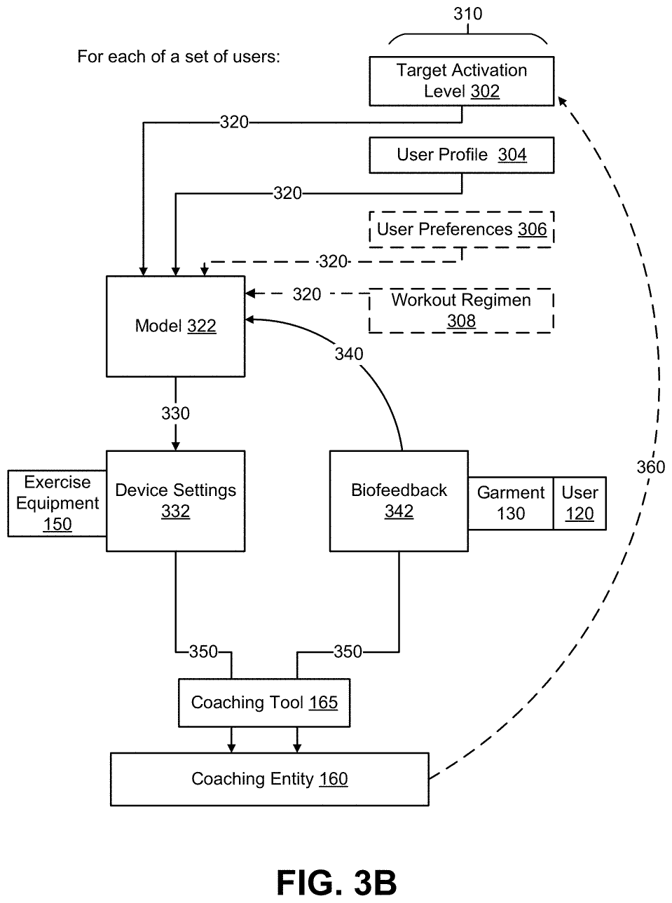

FIG. 3A depicts a flowchart of a method 300 for automatically modulating operation states of connected exercise equipment (such as the connected exercise equipment 150 of FIG. 1), in order to produce desired levels of muscle activation for one or more users (such as the user 120 of FIG. 1), in accordance with one or more embodiments. In more detail, for each of a set of users, an exercise feedback system (such as exercise feedback system 100 shown in FIG. 1) receives a set of inputs 310 (described in more detail below in relation to FIG. 3B), processes 320 the set of inputs with one or more models, generates 330 control instructions for connected exercise equipment associated with the user(s), based on outputs of the one or more models, and receives 340 biofeedback parameters from the user(s) as the user(s) interact with the connected exercise equipment. In some embodiments, received biofeedback information can be provided as an input for generation 330 of additional control instructions for the connected exercise equipment in real time or near-real time, as the user(s) perform an exercise activity. As operation of the method 300 continues, information can be provided 350 to the coaching entity 160 (e.g., through coaching tool 165).

As shown in FIG. 3B, in relation to step 310, the exercise feedback system receives a set of inputs including a first input characterizing a target activation level 302 for an exercise session and a second input characterizing a user profile 304. The exercise feedback system can also receive a third input characterizing a user preference 306. The exercise feedback system can also receive additional inputs, including an input describing parameters of a desired exercise or workout regimen 308 for the user(s).

In relation to the first input characterizing the target activation level 302, the target activation level 302 (or target intensity) describes the desired degree of physical exertion of certain muscle group(s) for a particular exercise. The target activation level 302 can be defined in relation to a baseline activation level. In one embodiment, the baseline activation level is determined by the exercise feedback system by measuring the user's maximum ability (e.g., in terms of exertion, in terms of exertion to failure) for a particular physical exercise. For example, the baseline activation can be determined by detecting activation of the user's muscles, by the athletic garment, in relation to a maximum weight the user can deadlift or the fastest pace the user can run. Alternatively, the baseline activation level can be determined from a resting state of a user or another reference state.

Related to the target activation level 302 is the user's normalized activation. The user's normalized activation, is a measure of the user's activation relative to the baseline activation level for a particular physical exercise. Furthermore, the normalized activation can be determined across a set of muscles (e.g., as an aggregate measurement), and/or for individual muscles. The normalized activation and/or the baseline activation are dynamic and can change as the user becomes stronger and faster. Determination of normalized activation can be implemented according to embodiments described in U.S. application Ser. No. 15/676,917 filed 14 Aug. 2017 and incorporated in its entirety below as Appendix C.

In the embodiments shown in FIGS. 3A and 3B, the coaching entity 160 gives input, including the target activation level for one or more exercises, to the coaching tool 165. However, in other embodiments, the target activation level 302 can be provided as an input by the user or another suitable entity. The target activation level 302 can be set for each of a set of muscle groups associated with one or more exercise activities. The target activation level 302 can additionally or alternatively be set holistically for a user, in terms of overall muscle activation from the user's body. Activation levels, intensities, and other embodiments of target exercise parameters are described in one or more of: U.S. application Ser. No. 16/409,373 filed 10 May 2019 and incorporated in its entirety by this reference and below as Appendix A, U.S. application Ser. No. 15/762,542 filed 22 Mar. 2018 and incorporated in its entirety by this reference and below as Appendix B, U.S. application Ser. No. 15/676,917 filed 14 Aug. 2017 and incorporated in its entirety by this reference and below as Appendix C, and U.S. App. No. 62/671,309 filed 14 May 2018 incorporated in its entirety by this reference and below as Appendix D.

The target activation level 302, as shown in FIG. 3B, can be set by a coach or coaching entity 160, through the coaching tool 165, to target specific muscle groups, cardio or other forms of aerobic exercise, or other exercise forms at a uniform level of physical challenge across a group based on the individual user profiles, such that the coaching tool 165 transmits information capturing the target activation level 302 to the network 140 for controlling operation of the exercise feedback system 100. The type of workout desired by the coaching entity and/or the user can be determined as described in U.S. App. No. 62/671,309 filed 14 May 2018 incorporated in its entirety by this reference and below as Appendix D.

Inputs provided by the coaching entity 160 can be provided through input devices (e.g., touch input devices, audio input devices, etc.). For instance, in one embodiment, the coaching entity can provide inputs related to a desired target activation level verbally to a coaching tool 165, and the coaching tool 165 or other system component can apply natural language processing (NLP) to the verbally received input to extract the intent of the coaching entity 160.

In some embodiments, the target activation level can be defined with the coaching tool 165 as a percentage of baseline activation level. For example, the coach may designate one portion of a workout to be a 10-minute run on a treadmill at a target activation level of 70%, where 70% corresponds to 70% activation of the user's relevant muscles for the exercise, relative to the baseline activation level. The level of activation normalized by the user's baseline activation is known as normalized activation. In this example, users who are faster runners will have a faster pace than slower runners, given that 70% activation will be different for different users, based on differences in baseline activation level for different users.

In another example of this embodiment, the coaching entity 160, through the coaching tool 165, designates a workout segment of 10 squats on a weighted squat machine at 90% normalized activation, where the coaching tool 165 provides such parameters to the network 140. The parameters set by the coaching entity 160 are processed, with other inputs, by the model 322 to produce device settings 332, where in this example, the squat machine is subsequently set to the weight of each individual's 90% baseline activation based on the data in the user profile 304. The coaching entity 160 thus does not have to expressly tell each individual what weight to which they should set the machine, or manually adjust settings of each machine in relation to target activation levels across a group of users. Instead, the exercise feedback system calculates the squat machine weight setting based on the user's normalized activation.

### IIA. Methods—User Factors in Relation to Desired Outcomes

In relation to the second input characterizing the user profile 304, the user profile 304 describes and contains information about the particular individual user 120, which includes one or more of: demographic information, medical history, anatomic information, and the user's baseline activation. Demographic information can include age, gender, ethnicity, socioeconomic status, and other demographic information. Medical history may further include a risk of cardiovascular problems, a list of orthopedic injuries, surgical history, and other medical history information. Anatomic information may further include height, weight, limb lengths, and other user-specific aspects of musculoskeletal anatomy. The user profile 304 can be stored in memory, and the exercise feedback system can retrieve one or more elements of the user profile 304 and input the elements into the model 322, as described below.

In some embodiments, the user 120 can also add their own user preferences 306. User preferences 306 allow the users some freedom to customize their own workout. For example, in one embodiment, if the user wants to lessen their workout for reasons such as not feeling well, having an event after the workout, or other reasons, such inputs can be provided (through user-associated devices) to the model 322, and to generate device settings received by the exercise equipment 150 to reduce the user's normalized activation, while performing associated exercises, by a factor (e.g., a scaling factor of 15%) related to the user input. Other factors can relate to user constraints, such as work requirements or other social/family requirements.

Inputs can additionally or alternatively include user fatigue (e.g., real-time fatigue), as determined from the athletic garment 130 as the user performs a workout, where embodiments of methods and systems for characterization of fatigue is described in U.S. application Ser. No. 16/409,373 filed 10 May 2019 and incorporated in its entirety by this reference and below as Appendix A.

Adjustments made by the exercise feedback system can be performed incrementally and, adjustments can be made in different directions (e.g., up or down) to keep a user 120 in a desired target range given their capabilities. For example, a user 120, through a user device 125, may generate an input capturing a user preference 306 indicating a desire to increase the difficulty of their workout. The model 322, in response to the input, generates control instructions for associated devices, that produce an incremental increase in the device settings 332. If the garment 130 is providing biofeedback 342 that a user 120 is over-exerting their muscles, then the model 322, in real time, can generate device settings that produce an incremental decrease in device settings 332 (e.g., regardless of the user input) for the exercise equipment 150. For example, the user may be experiencing muscle fatigue, such as soreness, from a previous workout. The biofeedback 342 from the garment 130 indicates that the desired muscles groups are not reaching the target activation based on the fatigue. The model 322 generates device settings to reduce the user's normalized activation to accommodate muscle fatigue.

In some embodiments, the system includes architecture defining different portions of a workout regimens 308. The workout regimens 308 are stored in memory and accessed by the exercise feedback system 100, where parameters of the workout regimens are used as inputs to the model 322. In some embodiments, involving user selection, the user 120 may select one of these workout regimens 308, which have been pre-defined, and perform them independent of an active watching coaching entity 160. The workout regimens 308 may be pre-defined by a coaching entity 160, the user 120, or another entity. The workout regimens 308 may include a list of exercises, each associated with a number of repetitions and/or time to spend on each machine and/or a target activation level. When using a workout regimen 308, the garment 130 will still send biofeedback 342 about activation of muscle groups to the system 340.

As shown in FIGS. 3A and 3B, the exercise feedback system 100 includes architecture for processing the set of inputs with a model 322, and upon processing the set of inputs with the model 320, generates 330 an output including control instructions for an adjusting operation state of the connected exercise equipment 330 associated with a given user 120. The model 322 can generate outputs for exercise equipment 150 for different users 120, based on the target activation level 302. As such, in one embodiment, the coaching entity 160 can, through the coaching tool 165, set a target activation level 302 for a group of users he/she is training, and the model 322 can generate 330 control instructions for equipment 150 associated with each of the group of users, such that each user 120 can have his/her device automatically set based on each user's baseline activation level.

The model 322 processes the set of inputs 320 to generate a set of initial device settings matching the target activation level 302 for each user, based on muscle profiles associated with the target and baseline activation levels for each user. As the user begins to exercise, the model also receives biofeedback 340 from the athletic garment 130 coupled to the exercise feedback system 100 through the network 140. In one embodiment, a transformation model generates mappings between the activation level determined from biofeedback signals 342 provided by the athletic garment 130 and the initial device settings. The model 322 thereby processes the mappings to determine the device settings 332 and control the exercise equipment 150. The model 322 generates 330 a set of control instructions for connected exercise equipment 150. However, in other embodiments, the model 322 can implement another suitable model architecture.

Furthermore, the model 322 may be a machine learned model that is trained over time, in relation to different types of connected exercise equipment and/or different muscle groups associated with different users, in order to generate characterizations or mappings between target activation levels set by a coaching entity 160 and/or other entity, connected exercise equipment settings, and user muscle profiles (e.g., based on biofeedback data from the athletic garment). In relation to machine learning, the system(s) described can thus generate training and test data including inputs associated with one or more of: contextual data associated with the environment of the user(s) and activity of the user, user profiles, sensor data, attempted interventions/corrective actions, and other data; and outputs (e.g., analyzed data related to activation, form, etc.) associated with user performance in relation to achieving goals and correcting deficiencies. The system can thus generate training and/or test data from a single user or population of users.

In the context of machine learning and training of models associated with any portions(s) of the method (e.g., associated with providing outputs to coaching entities, associated with generation of control instructions for connected devices, etc.), the computing subsystem can implement one or more of the following approaches: supervised learning, unsupervised learning, semi-supervised learning, reinforcement learning, and any other suitable learning style. Furthermore, the machine learning approaches can implement any one or more of: random forest, a Bayesian method (e.g., naïve Bayes, averaged one-dependence estimators, Bayesian belief network, etc.), a kernel method, a clustering method, an artificial neural network model (e.g., a Perceptron method, a back-propagation method, a deep learning algorithm, a regression algorithm (e.g., ordinary least squares, logistic regression, stepwise regression, etc.), a decision tree learning method, a regularization, a dimensionality reduction method, an ensemble method (e.g., boosting, bootstrapped aggregation, etc.), and any suitable form of algorithm.

The control instructions associated with the different types of exercise equipment may alter various device settings 332 of the equipment. The control instructions vary the device settings 332 on the equipment to help optimize the user's workout. For example, control instructions sent to a weight lifting machine may increase or decrease the weight used. In another example, control instructions sent to a treadmill may increase or decrease the pace of running or incline of the machine. In another example, control instructions sent to a cable column may alter the position of and/or resistances of the cables (e.g., as shown in FIG. 5A) so that the users pulls/lifts at a different angle that better engages their muscles. In various embodiments, the system will notify the user 120 of how the control instructions are altering their workout. For example, the treadmill may announce or display to the user 120 the change in pace or incline before it happens.

As the user 120 interacts with the connected exercise equipment 150, the garment 130 worn by the user 120 generates signals. These signals are processed by the garment and its associated systems, as described in Appendices A through D and output as biofeedback 342. The exercise feedback system receives and processes the biofeedback 340. In some embodiments this is received by the model 322, such as depicted in FIG. 3B. The exercise feedback system receives and processes inputs 320 as well as biofeedback 342, as depicted in both FIGS. 3A and 3B. These are both used subsequently to generate 330 control instructions adjust device settings 332 for connected exercise equipment 150.

Control of the connected exercise equipment 150 can thus be implemented through mobile devices (e.g., mobile devices that operate as controllers for connected exercise equipment 150), through the cloud (e.g., via network 140), and/or through control and output functions of the athletic garment 130 as described in relation to the system above.

As shown in FIG. 3A, information and data relating to the process described above, in various embodiments, is provided to the coaching entity 350. Information provided to the coaching entity 350 may include device settings 332, biofeedback 342, and the inputs sent 320 to the model 310, which may further include target activation level 302, user profiles 304, user preferences 306, and workout regimens 308.

In some embodiments provision 350 of information is performed by the exercise feedback system 100 through the use of a coaching tool 165. Examples of a coaching tool 165 include an electronic tablet, smart phone, smart watch, laptop computer, desktop computer, or another such electronic device. In many embodiments the information and data is provided to the coaching tool 165 via an internet connection, such as a wireless internet connection (e.g., the network 140).

Providing 350 this information keeps the coaching entity 160 informed about the user(s) they are coaching in real-time or near real-time. This facilitates and improves the job of the coaching entity 160, providing 350 them with information about how their training settings are impacting the users 120. For example, in some embodiments, the biofeedback 342 provided 350 to the coaching entity 160 may indicate a user 120 is not lifting weights with a desired level of muscle activation. As such, the methods described allow the coaching entity 160 through associated tools, to and correct aspects of the user's performance to enable the user to achieve a performance goal for the exercise activity. In another example, information may be provided 350 to a coaching entity 160 that a particular user 120 is unable to keep up with their target activation level, which enables the coaching entity 160 to intervene and decrease the intensity of the workout and prevent possible injury. In another example, a user 120 is over-performing on their target activation level 302. The coaching entity 160 would be able to increase the intensity of the workout to better challenge the user 120.

In another example, a coaching entity 160 may be teaching a class or team of users 120. The coaching entity 160 may determine from the information provided 350 that the current exercise is not working out the desired muscles group(s) as intended by the coaching entity 160. The coaching entity 160 would be able to change the workout in the middle of the session to be able to better target the desired muscle groups across a group of users, in a manner that would be unachievable with a manual process in the timespan of a normal workout.

In some embodiments, the coaching entity 160, through coaching tool 165, can adjust 360 the target activation level 302 based on other triggering events. In the examples enumerated above, the coaching entity 160 can update the workout within the exercise feedback system, rather than manually adjusting individual workout device settings across many devices. Adjusting 360 the target activation level 302 would result in altering the device settings 332 and biofeedback 342. In the examples above, this could be used to automatically decrease intensity, increase intensity, and alter exercises to better target desired muscles groups, respectively. This improves the workout experience for both the users 120 and the coaching entities 160.

In some embodiments, these adjustments 360 to target activation level 302 by the coaching entity 360 could be done through the coaching tool 165. For example, if the coaching tool 165 is a tablet connected to the internet, the coaching entity 160 could see the information provided 350 to the coaching entity 160 displayed on an interface. In an example where users 120 are undergoing a running training exercise with connected treadmill equipment, the coaching entity 160 might intend for all the users 120 to do an all-out sprint toward the end of the running training exercise. In this example, the coaching tool 165 enables the coaching entity 160 to update the target activation level for all users, in real-time, in relation to the all-out sprint portion of the workout. In more detail, the coaching tool 165 receives an input indicating a desired adjustment to increase the target activation level 302 to 90%. The exercise feedback system then generates 330 instructions, through model 322, to adjust treadmill device settings 332 to match the target activation level 90% for all users 120, where the treadmill device settings for different users may differ based on each user's baseline activation level. The coaching entity 160 could make such adjustments 360 automatically from an interface of the coaching tool 165, facilitating a better workout.

In some embodiments, the coaching entity 160 can be remote from the user 120, and thus, may not need to be physically present with the user(s) 120. The network 140 connects the user 120, the athletic garment 130, and exercise feedback system 100 to the coaching entity 160, such as in the embodiment shown in FIG. 1. In embodiments where the network 140 is wireless the coaching entity 160 can work remotely. The coaching entity 160 can set and monitor workouts, while being provided 350 information about the workout and adjusting 360 the target activation level via the network 140. Furthermore, workouts associated with the coaching entity 160 can be real-time (e.g., live), or can alternatively be pre-scheduled and/or defined, with target activation levels 302 set by the coaching entity 160 prior to instances of performing a workout.

In some embodiments, the coaching entity 160 may not be a human entity. The coaching entity 160 can alternatively be a non-human entity, such as a virtual coaching entity executed using a system or software that contains coaching information about exercises that may be performed. In these embodiment, the coaching entity 160 would provide feedback about how a particular user is performing each exercise based on the information provided 350 processed by the coaching entity.

In some embodiments, the coaching entity 160 and the user 120 are working on a one-on-one basis. That is, there is one coaching entity 160 working directly with one user 120, rather than a group of users. The one-on-one coaching may occur with the coaching entity 160 physically present with the user 120. Alternatively, the coaching entity 160 can operate remotely, as previously discussed, providing feedback to the user 120 via the network 140.

In some embodiments, the exercise feedback system 100, with the model 322, can process inputs to create workouts based on the various exercise equipment 150 available to the user 120 (e.g., within a gym setting). In one such embodiment different types of exercise equipment 150 are connected to one another via a network 140, and as the user performs the workout, interactions with the different pieces of exercise equipment connected to the network track user performance, which can be used to dynamically modulate the workout. As such, the user's workout can be personalized not only based on a set target activation level 302, but user performance with a particular piece of exercise equipment can be used by the exercise feedback system 100 to dynamically guide the user 120 to subsequent pieces of exercise equipment in a manner that optimizes the user's workout based on connections between the pieces of exercise equipment and the network 140. That is, the user 120 may start by warming up on a treadmill machine, and subsequently be directed by the exercise feedback system via an interface on the treadmill to proceed to a leg press machine to continue the user's workout.

In some embodiments, one example of which is shown in FIGS. 5A and 5B, the exercise equipment does not contain electronic components that are capable of connecting to a network. For example, if the user were lifting free weights, doing pushups, or another exercise that does not directly involve mechanized equipment, the exercise feedback system 100 generates instructions for guiding the user 120 through an exercise with non-connected exercise equipment. In more detail, the control instructions can include a specific weight to use for a free weight activity and/or a number of repetitions to complete for the free weight activity, in order to achieve the target intensity level. In this embodiment, the model 322 can generate device settings 332 that are instructions to the user 120 for modulating aspects of the user's workout with non-connected exercise equipment based on information derived from an athletic garment 130 sensing activity of the user's muscles and connected to the exercise feedback system 100. For example, the weight used or the number of repetitions may be device settings adjusted for the non-connected exercise equipment during the workout to achieve the workout goals related to target activation level 302.

FIG. 4 is a diagram of entities involved in a training plan 410, which can include one or more workout regimens (e.g., such as example workout regimens described above), according to one or more embodiments. The network 140 facilitates execution of the training plan 410 through different exercises that may involve different instances of exercise equipment 150 associated with the user 120, who may be wearing the athletic garment 130, where the network 140 is also coupled to the exercise equipment 150, and a coaching entity 160 and/or coaching tool 165, as described above. The network 140 may be wireless, such as a cloud-based network. The training plan 410 may be communicated to the user 120 and/or the coaching entity 160 via a user device 125 and/or the coaching tool 165.

As shown in FIG. 4, the training plan 410 can include a regimen overview 420, a specific exercise 430, and specialized feedback 440 related to user performance, based on biofeedback 342 from the athletic garment 130 coupled to the user. The regimen overview 420 can include an outline of exercises included in a current workout as part of the training plan. The outline can include a brief description of each exercise with accompanying images or icons. In one embodiment, the regimen overview 420 can include all exercises included in the current workout. In another embodiment, the regimen overview 420 may only include exercises that have not yet been completed. In relation to exercise completion, the regimen overview 420 can render or otherwise provide a distinction between exercises that have been completed and exercises that have not yet been completed.

The specific exercise 430 includes information about an exercise the user 120 is currently performing or is about to perform. The specific exercise 430 is provided to the user in visual or audio format by the exercise feedback system 100 via the user device 125, the exercise equipment 150, the coaching tool 165, or another device compatible with the network 140. The specific exercise 430 may include a demonstration 432 of the specific exercise 430, in video or other format. The demonstration 432 may take the form of a video or animation of a person performing the exercise. The demonstration 432 may take the alternate form of a series of images of a person or illustration of a person performing the steps of the exercise. The demonstration 432 may also include a detailed description of the specific exercise 430, which may further include a description of each step, an enumeration of muscle groups used, a specification of the number of repetitions or time duration of the specific exercise 430, and a specification of the weight, resistance, and/or incline to which the exercise equipment 150 should be set. The demonstration 432 may include any combination of videos, animations, images, illustrations, and description.

The specialized feedback 440 provided is information about how well the user 120 is performing the current (e.g., the specific exercise 430) and/or previous exercise. The specialized feedback may be provided to the user 120 and/or the coaching entity 160. Providing the specialized feedback 440 to the coaching entity 160 or user 120 is one way of performing corrective action 260, as shown in FIGS. 2A and 2B. The specialized feedback 440 may further include a feedback score 442, visual feedback 444, and audio feedback 446, examples of which are shown in FIGS. 5A, 5B, and 5C. The feedback score 442 provides specific information about how well the user 120 is performing the specific exercise 430. This may include a quantified score, which may be on a scale of 1 through 10. Other examples of feedback scores 442 are described in one or more of: U.S. application Ser. No. 16/409,373 filed 10 May 2019 and incorporated in its entirety by this reference and below as Appendix A, U.S. application Ser. No. 15/762,542 filed 22 Mar. 2018 and incorporated in its entirety by this reference and below as Appendix B, U.S. application Ser. No. 15/676,917 filed 14 Aug. 2017 and incorporated in its entirety by this reference and below as Appendix C, and U.S. App. No. 62/671,309 filed 14 May 2018 incorporated in its entirety by this reference and below as Appendix D.

The visual feedback 444 provides information, such as data, about the user's 120 performance through a visual mechanism, such as a display. Examples of a display include an electronic tablet, mobile phone, television, projection, electronic display on the exercise equipment 150, or any other electronic screen capable of being connected to a network 140. The visual feedback 444 may include the previously disclosed feedback score 442, the number of repetitions or amount of time remaining, the demonstration 432, the regimen overview 420, and other information that is part of the training plan 410. The visual feedback may also include an alert to the user 120 about their form or muscle engagement. The alert may be positive affirmation of correct form. The alert may alternatively be an indication of incorrect form, which may further include a cue for how to correct the incorrect form. The alert may precede, accompany, or follow a change in device settings 232, or a change in control instructions for the connected exercise equipment 150. The exercise feedback system can additionally or alternatively generate audio feedback 446 through one or more of: a smart speaker, a headset, headphones, including wireless headphones, or other electronic means of producing audible sound.

As such, in certain implementations, the system can generate a set of control instructions upon inputting performance data into a transformation model configured to return device settings, wherein the set of control instructions is configured to adjust settings of the exercise equipment used by the user in relation to performance of the activity.

For example, a user 120 is performing an exercise and the information sent to the coaching entity 160 indicates the user 120 is performing one of the common wrong forms of the particular exercise. The exercise feedback system 100 performs 260 a corrective action. In this example, the model 222 generates outputs that are used to provide specialized feedback 440 to the user 120 and coaching entity 160 about the improper form. The specialized feedback 440 may further include an audio and/or video notification to the user 120 about the improper form. Performing 260 the corrective action may also include adjusting the device settings 232, which may be done automatically if the exercise equipment 150 is connected to the network 140, as described in examples above.

Specialized feedback 440 provided to the coaching entity 160 and user 120 may additionally include information processed in the model 222 such as the form and effort data 224, the analysis 234, and the comparison 244. The form and effort data 224, the analysis 234, and the comparison 244 may take the form of a feedback score 442, visual feedback 444, and/or audio feedback 446. For example, the effort data 224 may be presented in the form of audio feedback 446 that announces the user 120 is putting too much weight on their right leg as they perform an exercise. In another example, the feedback score 442 may indicate on a scale of 1 through 10 how closely the user's 120 form matches that of a reference in the comparison 244. In another example, the analysis 234 of the user's 120 form may be represented as visual feedback 444 using color coding to show which muscles are meeting the target activation levels. In another example, a user 120 is given specialized feedback 440 in the form of an exercise change (e.g., “lean more to your left side in order to have proper form”). The exercise is changed to a different exercise specifically selected to help the user 120 build strength in particular muscle groups to enable the user 120 to perform the original exercise with the proper form and effort.

Specialized feedback 440 provided can also be configured to promote user engagement with interventions in a manner that optimizes or otherwise improves achievement of user goals and correction of deficiencies (e.g., in form, in performance). In one implementation, such specialized feedback can include visual feedback 444 and/or audio feedback 446. The visual feedback 444 and/or audio feedback 446 may be presented to both the user 120 and the coaching entity 160, which may be via the user device 125 or coaching tool 165, respectively. The visual feedback 444 and/or audio feedback 446 provided to the user 120 and coaching entity 160 may be the same or different. In examples, the feedback can provide high resolution rendered images of a set of muscle groups of the user associated with an activity, where the images depict in graphical and/or numeric form, how the user has progressed toward his or her goal (e.g., in a manner that surpasses the user's ability to otherwise physically observe his/her own progress). In particular, recommended actions provided by the system can be delivered in coordination with a rendering of digital objects informative of user performance toward the goal at a second resolution more detailed than a first resolution associated with physical observation of the user, wherein the rendering is provided to a client device of the user.

In another implementation, such specialized feedback can implement a social component enabled within an application (e.g., web application, mobile device application, etc.) environment, whereby the user is promoted to compete with entities in the user's social network to achieve goals. Such social competition can include structured challenges, punishments, and/or rewards provided using digital objects within the application environment, and include access (e.g., API access) and/or at least partial interactions with user social media accounts, in order to create a mechanism for user accountability in relation to goal achievement. As such, the system can be configured to share features derived from the performance dataset of the user with a cohort of entities associated with the user, within an online social network platform, to drive social engagement. Social engagement can be based on competitors separate from the user, or based on historical performance of the activity by the user.

In some embodiments, the coaching entity 160 can be consulted via video, call, text, or other electronic communication using the coaching tool 165 and/or user device 125. Using the electronic communication, a workout plan is generated or otherwise customized for the user 120 by the coaching entity 160. Thus, use of the coaching tool 165 and/or user device 125 allows the user 120 and coaching entity 160 to have a one-one-one interaction, even when the coaching entity 160 is not physically present with the user 120. Furthermore, aspects of the customized workout plan can be pushed to the user 120 (e.g., in a 1:1 interaction with a coaching entity 160, in an interaction between the user 120 and connected exercise equipment, in an interaction between the user 120 and an application executing on a mobile device of the user 120, etc.).

The information describing the training plan 410 may be displayed or otherwise broadcast by a client device 110, the exercise equipment 150, the coaching tool 165, user device 125, or other electronic devices connected to the network 140. Some embodiments of the display and broadcast of the training plan are found in FIGS. 5A, 5B, and 5C.

FIGS. 5A, 5B, and 5C are illustrations of the functionality of providing form and effort feedback and/or automating adjustments to exercise equipment operation based on sensor-detected data, according to some embodiments. FIG. 5A is an illustration 500 of an embodiment comprising audio feedback 546. At left, the user 520 is wearing an athletic garment 530 in the form of shorts and is using connected exercise equipment 550. At right is the performance of corrective action by the exercise feedback system, according to some embodiments. At bottom right is a representation of an indication of biofeedback, which may take the form of visual feedback 544, showing leg muscle engagement, which may be a representation of raw form and effort signals generated from the athletic garment 530. In another embodiment, the visual feedback 544 shown could be the analysis of the muscle engagement with respect to the target activation. At top right is a visual representation of audio feedback 546, providing a verbal cue to improve form and muscle engagement based on biofeedback.

FIG. 5B is an illustration 510 of an embodiment comprising the training plan 510 on a mobile app, which can be used on a user device 525. At left, the user 520b is wearing an athletic garment 530b in the form of shorts and using exercise equipment in the form of a kettlebell. At right is a graphic of a training plan 510 for use on a mobile app, according to one embodiment. At top right is a display of overall training goals as part of the larger training plan 510. At bottom right is a display of the current workout as part of the training plan 510, which may further include a regimen overview 520, information about the specific exercise 530 such as a demonstration, and specialized feedback 540 such as a feedback score, visual feedback, and audio feedback. At center right is specialized feedback 540 informing the user 520b that their glutes are being targeted in the current workout. The user 520b may be informed of the specialized feedback 540 about their glutes through visual feedback, such as a notification or display on the mobile app.

FIG. 5C is an illustration 520 of an embodiment comprising a target activation level 502 and both visual feedback 544c and audio feedback 546c. In this embodiment, the user is participating remotely in an exercise class being led by a coaching entity 560. At center is visual feedback 544c on a display of the connected exercise equipment, in this case a spinning bicycle. At the top of the figure is a representation of the audio feedback 546c provided by the coaching entity 560. At bottom is a representation of the adjustment of the device settings 532 based on biofeedback and target activation level 502. In this example, the target activation is >80%, as shown in parenthesis. The visual feedback 544c may inform the user that the bike will automatically adjust intensity until their target activation level 502 is greater than 80% of their baseline activation. At bottom right is visual feedback 544c of the user's muscle engagement.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving a set of signals related to user performance of an activity, from a garment worn by a user, the garment including a set of sensors configured to generate the set of signals;
extracting a performance dataset upon processing the set of signals, the performance dataset characterizing form and exertion features across a set of muscles of the user in association with performance of the activity, wherein determining the performance dataset comprises generating, for each of the set of muscles, a value of normalized activation relative to a baseline activation for the set of muscles of the user;
generating, from the performance dataset, an analysis of the user performing the activity based upon a comparison to a reference profile associated with a goal of the user;
generating a recommended action based upon the analysis and executing the recommended action through an exercise feedback system in communication with the garment; and
promoting engagement between the user and the exercise feedback system based upon the analysis and in coordination with executing the recommended action, wherein promoting engagement comprises returning, for communication to the user, an output indicating performance of the user relative to performance of a competitor.

2. The method of claim 1, wherein the set of signals related to user performance of the activity comprises signals derived from one or more of: a subset of the set of muscles being activated, temporal aspects associated with activation of the subset of muscles, and intensity aspects associated with activation of the subset of muscles.

3. The method of claim 2, wherein extracting the performance dataset further comprises: extracting form, balance, and exertion of the user during performance of the activity, upon processing the set of signals with a performance model configured to transform the set of signals into values of features of the performance dataset.

4. The method of claim 3, wherein generating the analysis further comprises generating a characterization of performance of the activity by the user in relation to the reference profile.

5. The method of claim 1, wherein the baseline activation is derived from a maximum exertion value of at least one of the set of muscles of the user.

6. The method of claim 1, wherein the goal of the user is adjusted based on user input associated with a lifestyle constraint of the user.

7. The method of claim 1, wherein the recommended action comprises a rendering of digital objects informative of user performance toward the goal at a second resolution more detailed than a first resolution associated with physical observation of the user, wherein the rendering is provided to a client device.

8. The method of claim 1, wherein the recommended action comprises sharing features derived from the performance dataset of the user with a cohort of entities associated with the user, within an online social network platform.

9. The method of claim 1, wherein the reference profile comprises a set of target activation features derived from an athlete performing the activity.

10. The method of claim 1, wherein the recommended action comprises a set of control instructions configured for delivery to an exercise equipment associated with the activity.

11. The method of claim 10, further comprising generating the set of control instructions upon inputting the performance dataset into a transformation model configured to return device settings, wherein the set of control instructions is configured to adjust settings of the exercise equipment used by the user in relation to performance of the activity.

12. The method of claim 1, wherein the competitor comprises at least one of an entity separate from the user, and a historical performance of the activity by the user.

13. A method comprising:
receiving a set of signals related to user performance of an activity, from a garment worn by a user, the garment including a set of sensors configured to generate the set of signals;
extracting a performance dataset upon processing the set of signals, the performance dataset characterizing form and exertion features across a set of muscles of the user in association with performance of the activity;
generating, from the performance dataset, an analysis of the user performing the activity based upon a comparison to a reference profile associated with a goal of the user;
generating a recommended action based upon the analysis and executing the recommended action through an exercise feedback system in communication with the garment; and
promoting engagement between the user and the exercise feedback system based upon the analysis and in coordination with executing the recommended action.

14. The method of claim 13, wherein the set of signals related to user performance of the activity comprises signals derived from one or more of: a subset of the set of muscles being activated, temporal aspects associated with activation of the subset of muscles, and intensity aspects associated with activation of the subset of muscles.

15. The method of claim 14, wherein the set of signals further comprises signals derived from a set of environment sensors in an environment of the user, wherein the set of environment sensors comprises a temperature sensor and an altitude sensor.

16. The method of claim 14, wherein the performance dataset is further derived from a contextual dataset derived from descriptions of the activity being performed.

17. The method of claim 13, wherein the baseline activation is derived from a maximum exertion value of at least one of the set of muscles of the user.

18. The method of claim 13, wherein the recommended action comprises a rendering of digital objects informative of user performance toward the goal at a second resolution more detailed than a first resolution associated with physical observation of the user, wherein the rendering is provided to a client device.

19. The method of claim 13, wherein generating the recommended action comprises implementing a model trained with a training dataset derived from input data from the set of signals, a user profile, and performance of the user in response to a set of historical recommended actions provided to a population of users associated with the user profile and in relation to performing the activity.

20. The method of claim 13, further comprising generating a set of control instructions upon inputting the performance dataset into a transformation model configured to return the set of control instructions for exercise equipment associated with the activity, wherein the set of control instructions is configured to adjust settings of the exercise equipment used by the user in relation to performance of the activity.
